(19) United States
(12) Patent Application Publication
(10) Pub. No.: US 2003/0147792 A1
(43) Pub. Date: Aug. 7, 2003

(54) Water-soluble and non-water-soluble materials separation device

(76) Inventors: Ming-Hui Chou, Panchiao City (TW); Li-Jung Chu, Taipei (TW)

Correspondence Address: Jackson Walker L.L.P., Suite 2100, 112 E. Pecan Street, San Antonio, TX, 78205, US

(21) Appl. No.: 10/068,062

(22) Filed: Feb. 5, 2002

(51) Int. Cl. B01D 1/00; B01D 12/00

(52) U.S. Cl. 422/269; 422/255; 422/261

(57) ABSTRACT

A water-soluble and non-water-soluble materials separation device has multiple stirring zones and multiple precipitation zones alternately arranged with the multiple stirring zones. Baffles are respectively provided between the stirring zones and the precipitation zones. Guiding plates are respectively and spatially located in the device to guide solution flow to a center of the baffle. Extraction pipes are provided in the precipitation zones so as to allow formation of precipitation to be collected in the concentration zone. The precipitation is collected from a bottom outlet in the collection tank.

### BACKGROUND OF THE INVENTION

1. Field of the Invention

The present invention relates to a separation device, and more particularly to a separation device for separating water-soluble and non-water-soluble materials by repeated precipitation.

2. Description of Related Art

Products from chemical reactions often are separated into water-soluble and non-water-soluble categories. For example:

MnSo₄+Na₂CO₃→MnCO₃+Na₂SO₄

When solvent MnSo₄ is added with Na₂CO₃, the product will be MnCO₃ and Na₂SO₄, wherein the MnCO₃ is non-water-soluble and Na₂SO₄ is water-soluble. In order to separate these two different products, the user often has to repeatedly use the curing process to extract the solution in the upper portion of the reaction tank out of the reaction tank after addition of a chemical material to facilitate the separation of these two different products and after stirring of the solution. When employing this curing method, the user has to wait for at least one day to allow the precipitation to completely sink to the bottom of the reaction tank every time the solution is stirred. Further, during the process, the user will have to add clean water repeatedly so as to lessen the concentration of the solution every time the solution is removed out of the reaction tank. After several times of repeating the same process, the precipitation is obtained. However, the process wastes a lot of water to lessen the concentration, and also the extracted solution is not pure. That is, the retained precipitation still has the water-soluble material and the solution also contains the non-water-soluble material.

To overcome the shortcomings, the present invention tends to provide an improved separation device to mitigate and obviate the aforementioned problems.

### SUMMARY OF THE INVENTION

The primary objective of the present invention is to provide a water-soluble and non-water-soluble materials separation device. The device has multiple layers of reaction zones superposed with one another and stirring blades provided in at least one of the reaction zones so as to fully mix the precipitation with the solution. Furthermore, extraction pipes are provided in the reaction zones that have no stirring blades so that after the solution is stirred and urged upwards by the stirring blades, the precipitation flowing into the extraction pipes sinks. After at least one precipitating process in the reaction zones, eventually the precipitation is collected in a collection tank.

Other objects, advantages and novel features of the invention will become more apparent from the following detailed description when taken in conjunction with the accompanying drawings.

### BRIEF DESCRIPTION OF THE DRAWINGS

FIG. 1 is a side plan view of the separation device with partial in section;

FIG. 2 is a cross sectional view of the separation device by the line 2-2 in FIG. 1;

FIG. 3 is a cross sectional view of the separation device by the line 3-3 in FIG. 2; and

FIG. 4 is a cross sectional view of the separation device by the line 4-4 in FIG. 2.

### DETAILED DESCRIPTION OF THE PREFERRED EMBODIMENT

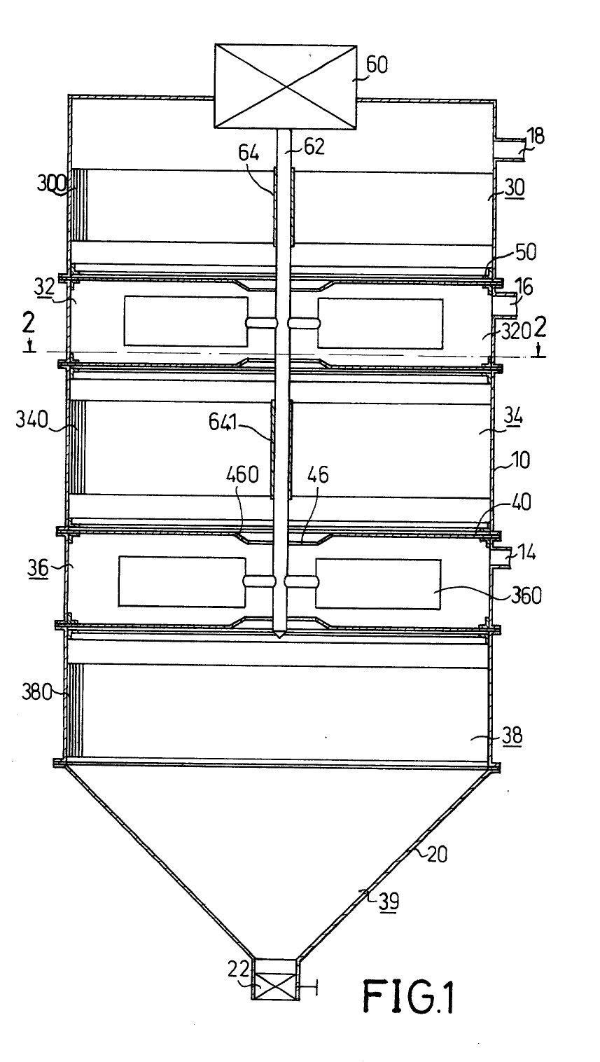

With reference to FIG. 1, the water-soluble and non-water-soluble materials separation device is composed of a tank (10) and a conical collection tank (20) provided at a bottom of and communicates an interior of the tank (10).

The tank (10) is divided into, from top to bottom, a top precipitation zone (30), a primary stirring zone (32), a primary precipitation tank (34), a secondary stirring zone (36), a bottom precipitation zone (38) and a concentration zone (39) inside the collection tank (20).

The top precipitation zone (30) has multiple extraction pipes (300) fully arranged in the top precipitation zone (30) and each having a length 5 to 20 times larger than the diameter of each of the extraction pipes (300). Each extraction pipe (300) is 10 to 20 degrees from vertical to the surface level. An outlet (18) is defined in a top portion of the tank (10).

Stirring blades (320) are provided in the primary stirring zone (32). An inlet (16) is defined in a side of the tank (10) in the primary stirring zone (32).

Second extraction pipes (340) are provided in the primary precipitation zone (34). Each second extraction pipe (340) has a diameter, and a length 5 to 20 times larger than the diameter. Each second extraction pipe (340) is vertical with respect to the surface level of the water.

Second stirring blades (360) are provided in the secondary stirring zone (36) which has a water inlet (14) defined in a side of the tank (10) in the secondary stirring zone (36).

Like the top precipitation zone (30), the bottom precipitation zone (38) has multiple third extraction pipes (380) each having a length and a diameter 5 to 20 times less than the length and being inclined by 10 to 20 degrees relative to water level.

A motor (60) is mounted on top of the tank (10) and has an axle (62) extending from the motor (60) through the top precipitation zone (30), the primary stirring zone (32) and into the secondary stirring zone (36). A first tube (64) is mounted between the top precipitation zone (30) and the primary stirring zone (32), and has the axle (62) extending therethrough. A second tube (641) is mounted between the primary precipitation zone (34) and the secondary stirring zone (36) and has the axle (62) extending therethrough and into the secondary stirring zone (36). With the assistance of the first tube (64), the second tube (641) and the axle (62), the motor (60) is able to drive the stirring blades (320) and the second stirring blade (360) in the primary stirring zone (32) and the secondary stirring zone (36) respectively.

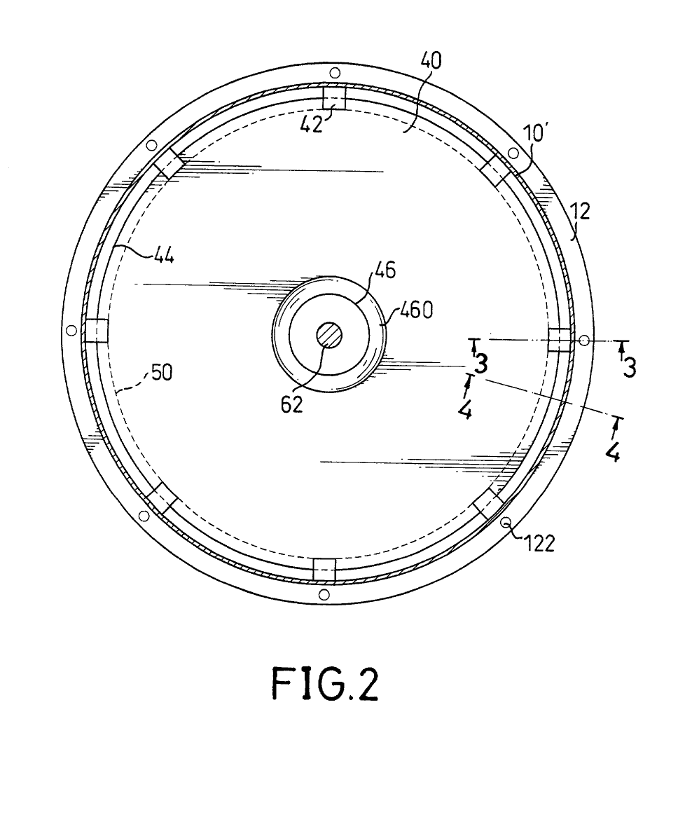

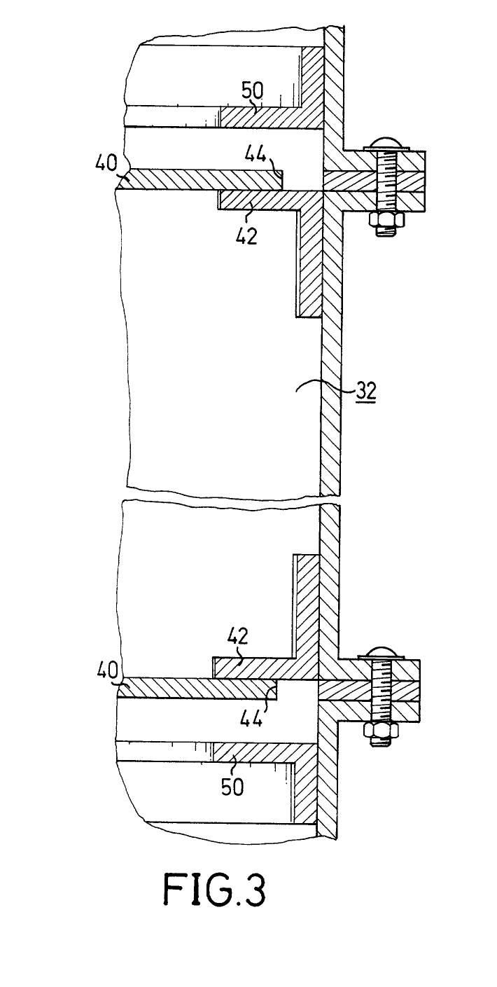

With reference to FIGS. 2 and 3, a baffle (40) is provided between the top precipitation zone (30) and primary stirring zone (32), the primary stirring zone (32) and the primary precipitation zone (34), the primary precipitation zone (34) and the secondary stirring zone (36) and between the secondary stirring zone (36) and the bottom precipitation zone (38). Each baffle (40) is secured to an inner face of the tank (10) by a positioning plate (42) which is securely engaged with the inner face of the tank (10). Each of the baffles (40) has a central opening (46) aligned with each other to allow the extension of the axle (62), and a tapered periphery (460) formed on a periphery defining the central opening (46). An annular gap (44) is defined between a distal edge of the baffle (40) and the inner face of the tank (10). Further, multiple guiding plates (50) are securely provided on the inner face of the tank (10). It is to be noted that the positioning plate (42) to position the baffle (40) between the top precipitation zone (30) and the primary stirring zone (32) is below the baffle (40) and secured to the inner face of the tank (10). The guiding plate (50) is spatially apart from the baffle (40) between the top precipitation zone (30) and the primary stirring zone (32) and is on top of the baffle (40). The positioning plate (42) to position the baffle (40) between the primary stirring zone (32) and the primary precipitation zone (34) is on top of the baffle (40) and secured to the inner face of the tank (10). The guiding plate (50) is spatially parted from the baffle (40) between the primary stirring zone (32) and the primary precipitation zone (34) and is below the baffle (40). Further, the guiding plate (50), the baffle (40) and the positioning plate (42) among the primary precipitation zone (34), the secondary stirring zone (36) and the bottom precipitation zone (38) are arranged in the same manner.

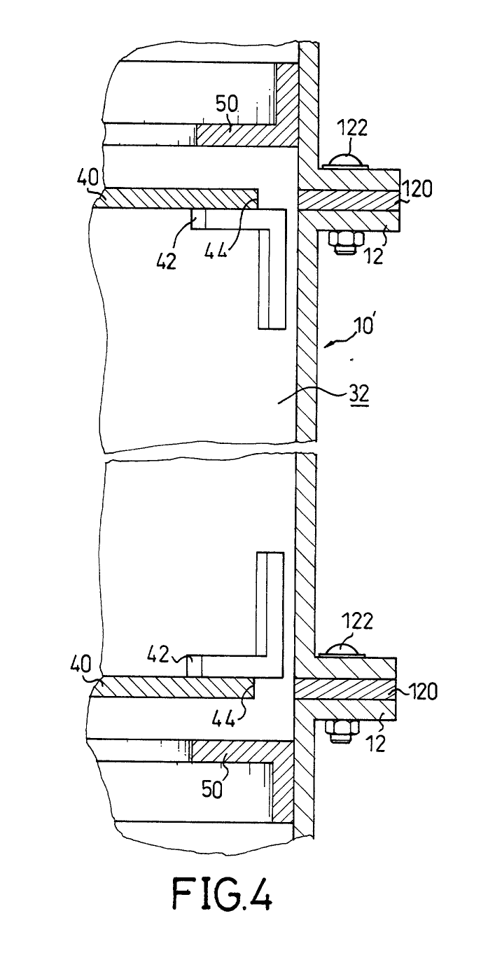

With reference to FIGS. 2 and 4, it is seen that the tank (10) may be composed of multiple secondary tanks (10′) each having a flange (12) extending outward. With such, when the secondary tanks (10′) are assembled, a water proof sealing pad (120) is provided between two adjacent flanges (12) so as to prevent an outflow of liquid contained inside the tank (10) and screws (122) are employed to secure the engagement between two adjacent flanges (12).

Before the separation device in accordance with the present invention is in operation, water is added into the tank (10) from the water inlet (14) in the secondary stirring tank (36). Because the outlet (18) is defined in the top portion of the tank (10), continuous addition of water into the tank (10) will force the water to flow upward inside the tank (10). Meanwhile, the material to be separated by the separation device is added into the tank (10) from the inlet (16) in the primary stirring zone (32). The material will be stirred by the stirring blade (320) to fully mix with the water. The solution inside the primary stirring zone (32) and stirred by the stirring blades (320) will be forced to flow laterally by the centrifugal force generated by the stirring such that eventually the solution is forced to flow upward or downward from the annular gap (44) between the primary stirring zone (32) and the top precipitation zone (30) and between the primary stirring zone (32) and the primary precipitation zone (34). Because a width of the guiding plate (50) is larger than a width of the annular gap (44), the solution flowing upward enters the top precipitation zone (30) and is guided by the guiding plate (50) on top of the baffle (40) to flow to a center of the baffle (40). Simultaneously, due to the water inside the tank (10) being constantly flowing upward, the solution in the top precipitation zone (30) enters the first extraction pipes (300) from the bottom thereof. Further, because the length of the extraction pipe (300) is much larger than the diameter of the extraction pipe (300), solution inside the extraction pipe (300) will generate a laminar flow, and because the extraction pipes (300) are inclined relative to the water surface level, precipitation is formed inside the extraction pipes (300). The precipitation inside the extraction pipes (300) will sink to the bottom of the extraction pipes (300) and then is driven by the solution current on top of the baffle (40) to flow to the center of the baffle (40). Therefore, the precipitation will sink to the primary stirring zone (32) from the central opening (46) and along the tapered periphery (460) in the baffle (40). Then clean water flows out of the tank (10) from the outlet (18) due to the upward flowing of the solution inside the tank (10).

The solution flowing downward to the primary precipitation zone (34) from the annular gap (44) is guided by the guiding plate (50) below the baffle (40) between the primary stirring zone (32) and the primary precipitation zone (34) to flow toward the center of the baffle (40). However, because the current constantly flows upward, the solution in the primary precipitation zone (34) is forced to enter the primary stirring zone (32). Due to the solution velocity difference between the primary stirring zone (32) and the primary precipitation zone (34), the substance inside the solution entering the primary precipitation zone (34) will precipitate in the second extraction pipes (340) in the primary precipitation zone (34). Moreover, because the flux of water added to the tank (10) is precisely calculated and controlled, the upward velocity of solution is much lower than the downward velocity of the precipitation in the second extraction pipes (340). Therefore, the precipitation effect inside the second extraction pipes (340) will not be affected by the current of the solution outside the second extraction pipes (340). Therefore, precipitation (the non-water-soluble material) will fall on the top face of the baffle (40) below the primary precipitation zone (34). Meantime, the water-soluble material inside the remaining solution is guided to flow out of the second extraction pipes (340) by the upward current and then enter the primary stirring zone (32) from the central opening (46) of the baffle (40) so as to start the previous process all over again.

The precipitation (non-water-soluble material) sunk to the secondary stirring zone (36) from the central opening (46) in the baffle (40) between the primary precipitation zone (34) and the secondary stirring zone (36) is stirred by the second stirring blades (360). The stirred solution partly flows upward to the primary precipitation zone (34) from the annular gap (44) and partly flows downward to the bottom precipitation zone (38).

The solution flowing to the primary precipitation zone (34) will be guided by the guiding plate (50) between the primary precipitation zone (34) and the secondary stirring zone (36) to flow to the center of the baffle (40), such that the precipitation in the second extraction pipes (340) is also forced to flow to the center of the baffle (40) and eventually falls into the secondary stirring zone (36). The remaining solution is still constantly flowing upward from the second extraction pipes (340).

The solution flowing to the bottom precipitation zone (38) is guided by the guiding plate (50) between the secondary stirring zone (36) and the bottom precipitation zone (38) to flow to the center of the baffle (40), such that the precipitation in the third extraction pipes (380) is also forced to flow to the center of the baffle (40) and eventually falls into the concentration zone (39) in the collection tank (20). The remaining solution is still constantly flowing upward from the third extraction pipes (380) to the secondary stirring zone (36). The precipitation concentrated in the concentration zone (39) will be finally collected at a bottom outlet (22) defined in a bottom of the collection tank (20).

In order to fully mix the water with the subject to be separated in the separation device of the present invention, the water velocity generated by the stirring blades (320) should be kept 50-1500 times larger than the precipitation speed in the top precipitation zone (30). Because the water velocity requirement in the secondary stirring zone (36) is smaller than that in the primary stirring zone (32), the size of the second stirring blades (360) is smaller than that of the stirring blades (320).

Furthermore, in order to smooth the formation of the precipitation, the solution velocity around the annular gap (44) on top and bottom of the primary stirring zone (32) should be kept to be 5-50 times larger than the precipitation speed.

The approach required to maintain the solution velocity is to adjust the distance between the guiding plate (50) and the baffle (40) so that the volume of the solution flowing through the annular gap (44) is able to be adjusted. However, the adjustment manner comprises various methods and because they are conventional in the art, detailed description thereof is thus omitted hereinafter.

Moreover, the constant upward flow of the solution is controlled by the constant input of water from the water inlet (14) so as to maintain the upward movement of the solution in the tank (10). Besides the input volume of the subject to be separated in the separation device of the present invention is also intensively monitored so as to acquire a complete mix between the water and the subject and to maintain the precipitation speed is always larger than the solution's upward movement.

After the solution is repeatedly precipitated consecutively in the tank (10), the water-soluble material and non-water-soluble materials are successfully and effectively separated.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A water-soluble and non-water-soluble materials separation device comprising:
a tank with multiple stirring zones, multiple precipitation zones alternately arranged with the stirring zones, an outlet defined in a top portion of the tank, an inlet defined adjacent to the outlet and a water inlet defined in a bottom portion of the tank; and
a collecting tank engaged with and communicating the tank, wherein each precipitation zone has multiple extraction pipes and each stirring zone has stirring blades,
whereby solution containing therein water-soluble and non-water-soluble materials is able to be added into the tank and mixed with water, which is added from the water inlet and flows from a bottom to a top in the tank, in the stirring zones so as to repeatedly allow formation of precipitation in the precipitation zones and collection of the precipitation in the collection tank.

2. The separation device as claimed in claim 1, wherein the collection tank is conical.

3. The separation device as claimed in claim 2, wherein the tank is sequentially divided into a top precipitation zone, a primary stirring zone, a primary precipitation zone, a secondary stirring zone, a bottom precipitation zone and a concentration zone, wherein the concentration zone is defined in the collection tank.

4. The separation device as claimed in claim 1, wherein the tank is sequentially divided into a top precipitation zone, a primary stirring zone, a primary precipitation zone, a secondary stirring zone, a bottom precipitation zone and a concentration zone, wherein the concentration zone is defined in the collection tank.

5. The separation device as claimed in claim 3, wherein the top precipitation zone has multiple extraction pipes.

6. The separation device as claimed in claim 5, wherein each extraction pipe has a diameter and a length 5-20 times larger than the diameter.

7. The separation device as claimed in claim 5, wherein the extraction pipes are inclined for 10 to 20 degrees relative to water level.

8. The separation device as claimed in claim 3, wherein the outlet is defined in the top precipitation zone at a side face of the tank.

9. The separation device as claimed in claim 3, wherein the inlet is defined in the primary stirring zone.

10. The separation device as claimed in claim 3, wherein the primary precipitation zone has multiple second extraction pipes,
wherein each second extraction pipe has a diameter and a length 20 to 200 times larger than the diameter.

11. The separation device as claimed in claim 10, wherein the second extraction pipes are vertical with respect to water level.

12. The separation device as claimed in claim 3, wherein the water inlet is defined in the secondary stirring zone.

13. The separation device as claimed in claim 3, wherein the bottom precipitation zone has multiple third extraction pipes,
wherein each third extraction pipe has a diameter and a length 5 to 20 times larger than the diameter.

14. The separation device as claimed in claim 3, wherein the collection tank has a bottom outlet for collecting precipitation.

15. The separation device as claimed in claim 3, wherein the secondary stirring zone has second stirring blades provided therein and the tank has a motor mounted on a top thereof and an axle extending from the motor to drive the stirring blades and the second blades.

16. The separation device as claimed in claim 3, wherein a baffle is provided between the top precipitation zone and primary stirring zone, the primary stirring zone and the primary precipitation zone, the primary precipitation zone and the secondary stirring zone and between the secondary stirring zone and the bottom precipitation zone,
wherein each baffle is secured to an inner face of the tank by a positioning plate which is securely engaged with the inner face of the tank, and each baffle has a central opening aligned with each other and a tapered periphery formed on a periphery defining the central opening,
wherein an annular gap is defined between a distal edge of the baffle and the inner face of the tank.

17. The separation device as claimed in claim 16, wherein multiple guiding plates are securely provided on the inner face of the tank to guide solution flow toward a center of the baffle,
wherein the positioning plate to position the baffle between the top precipitation zone and the primary stirring zone is below the baffle and secured to the inner face of the tank.

18. The separation device as claimed in claim 17, wherein the guiding plate is spatially *parted from the baffle between the top precipitation zone and the primary stirring zone and is on top of the baffle,
the positioning plate to position the baffle between the primary stirring zone and the primary precipitation zone is on top of the baffle and secured to the inner face of the tank.

19. The separation device as claimed in claim 18, the guiding plate is spatially apart from the baffle between the primary stirring zone and the primary precipitation zone and is below the baffle.

20. The separation device as claimed in claim 19, wherein the guiding plate has a width larger than a width of the annular gap.
